(19) United States
(12) Patent Application Publication
(10) Pub. No.: US 2025/0073580 A1
(43) Pub. Date: Mar. 6, 2025

(54) INFORMATION PROCESSING PROGRAM, INFORMATION PROCESSING METHOD, AND INFORMATION PROCESSING APPARATUS

(71) Applicant: KOEI TECMO GAMES CO., LTD., Yokohama-shi (JP)

(72) Inventor: Yuta KOBAYASHI, Kanagawa (JP)

(21) Appl. No.: 18/613,156

(22) Filed: Mar. 22, 2024

(30) Foreign Application Priority Data
Sep. 6, 2023 (JP) 2023-144879

(51) Int. Cl. A63F 13/45; A63F 13/52

(52) U.S. Cl. CPC A63F 13/45; A63F 13/52

(57) ABSTRACT

An information processing program causes a computer to execute, in a game in which a player enters a divided region and the player acquires the region when a predetermined condition is satisfied, the game using position information, acquiring a plural types of values related to scale of the region acquired by the player, and updating a degree of progress of the game of the player by using at least one value of the plural types of values.

### CROSS-REFERENCE TO RELATED APPLICATION

This application is based on and claims priority under 35 USC 119 from Japanese Patent Application No. 2023-144879, filed on Sep. 6, 2023, the disclosure of which is incorporated by reference herein.

### BACKGROUND

### Technical Field

The present disclosure relates to an information processing program, an information processing method, and an information processing apparatus.

### Related Art

Conventionally, position information games have been known in which a game progresses on the basis of position information of a terminal held by a player.

For example, Japanese Patent Application Laid-Open (JP-A) No. 2022-076018 discloses a position information game in which a game progresses as a game character controlled by a player acquires an experience value by beating an enemy character and the game character is leveled up according to the acquired experience value.

By the way, an unfair situation for each player sometimes occurs in the position information game in a case in which degrees of progress of games of players (for example, levels of the players or the like) are updated according to one criterion, for example, only sizes of regions acquired by the players.

### SUMMARY

An object of the disclosure is to provide an information processing program, an information processing method, and an information processing apparatus capable of suppressing unfairness in a degree of progress of a game for each player in a position information game.

An information processing program according to a first aspect causes a computer to execute: acquiring a plurality of types of values related to each scale of a plurality of regions acquired by a player in a position information game for acquiring the regions in the game corresponding to position information of the player when a predetermined condition is satisfied; and updating a degree of progress of the game of the player by using at least one type of value among the plurality of types of values.

An information processing program according to a second aspect is the information processing program according to the first aspect, in which the plurality of types of values related to the scale of the regions include an index value corresponding to a size of each of the regions and a number of the regions.

An information processing program according to a third aspect is the information processing program according to the first or second aspect, in which the degree of progress is upgraded by comparing at least one type of value among the plurality of types of values with a threshold set according to the degree of progress.

An information processing program according to a fourth aspect is the information processing program according to the third aspect, in which the degree of progress is upgraded to a higher degree in a case in which a cumulative value of each of the plurality of types of values becomes a threshold or larger set according to the degree of progress for each of the plurality of types of values.

An information processing program according to a fifth aspect is the information processing program according to the third aspect, in which the degree of progress is upgraded to a higher degree in a case in which any one type of value of the plurality of types of values acquired by the player after being upgraded in the degree of progress most recently becomes a threshold or larger set according to the degree of progress for any one type of value of the plurality of types of values.

An information processing program according to a sixth aspect is the information processing program according to the second aspect, in which a first threshold used for comparison with the index value is calculated by multiplying a second threshold, used for comparison with the number, by a representative value of the index values of the plurality of regions.

An information processing program according to a seventh aspect is the information processing program according to any one of the first to fifth aspects, in which presentation is performed in a case in which the degree of progress is updated such that the player is capable of selecting any of the plurality of types of values to be used for updating the degree of progress.

An information processing program according to an eighth aspect is the information processing program according to any one of the first to fifth aspects, in which the degree of progress is upgraded further using at least one of a value of land in a real space corresponding to the region, a moving speed of the player in the real space, and a moving time of the player in the real space.

An information processing method according to a ninth aspect includes: acquiring, by a computer, a plurality of types of values related to each scale of a plurality of regions acquired by a player in a position information game for acquiring a region in the game corresponding to position information of the player when a predetermined condition is satisfied; and updating, by the computer, a degree of progress of the game of the player by using at least one type of value among the plurality of types of values.

An information processing apparatus according to a tenth aspect includes a processor, the processor being configured to: acquire a plurality of types of values related to each scale of a plurality of regions acquired by a player in a position information game for acquiring a region in the game corresponding to position information of the player when a predetermined condition is satisfied; and update a degree of progress of the game of the player by using at least one type of value among the plurality of types of values.

According to the disclosure, it is possible to suppress the unfairness in the degree of progress of the game for each player.

### BRIEF DESCRIPTION OF THE DRAWINGS

Exemplary embodiments of the present disclosure will be described in detail based on the following figures, wherein:

FIG. 1 is a block diagram illustrating an example of a configuration of an information processing system;

FIG. 2 is a block diagram illustrating an example of a hardware configuration of an information processing apparatus;

FIG. 3 is a view for describing a region in a game;

FIG. 4 is a diagram illustrating an example of a movement path of a player;

FIG. 5 is a diagram for describing a case where a degree of progress of the game is updated using only the number of regions;

FIG. 6 is a diagram for describing a case where the degree of progress of the game is updated using only sizes of the regions;

FIG. 7 is a block diagram illustrating an example of a functional configuration of the information processing apparatus;

FIG. 8 is a view illustrating an example of a determination table;

FIG. 9 is a flowchart illustrating an example of a progress degree update process;

FIG. 10 is a view illustrating an example of a screen for selection of a parameter to be used for level-up; and

FIG. 11 is a view illustrating an example of a display screen of a level-up condition.

### DETAILED DESCRIPTION

Hereinafter, exemplary embodiments of the technology of the disclosure will be described in detail with reference to the drawings.

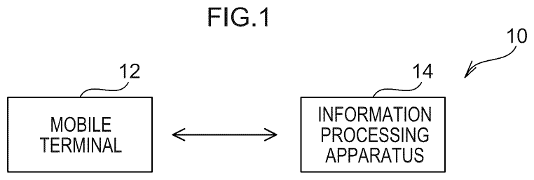

First, a configuration of an information processing system 10 according to the embodiment will be described with reference to FIG. 1. As illustrated in FIG. 1, the information processing system 10 includes a mobile terminal 12 used by a game player and an information processing apparatus 14.

Examples of the mobile terminal 12 include a smartphone and a tablet terminal. Examples of the information processing apparatus 14 include a server computer and a computer such as a cloud server. The information processing system 10 provides a game (hereinafter, referred to as “position information game”) that uses position information of the mobile terminal 12.

Each of the mobile terminal 12 and the information processing apparatus 14 is connected to a network and can transmit and receive data to and from each other. The game progresses as the mobile terminal 12 and the information processing apparatus 14 transmit and receive data via the network. Although a case where the position information game is provided as a so-called online game is illustrated in FIG. 1 as an example, the disclosed technology is not limited to such an aspect. In a case in which the position information game can be played offline, the information processing system 10 does not necessarily include the information processing apparatus 14. That is, the information processing apparatus 14 is not an essential component in the disclosure.

The mobile terminal 12 executes an application program configured to play the game to provide a player with an environment for playing the game corresponding to the application program. The mobile terminal 12 includes an input device and a display device, such as a touch panel display, and the player performs various inputs via the input device. In addition, the display device displays various game screens on the basis of data transmitted from the information processing apparatus 14.

In addition, the mobile terminal 12 includes a global positioning system (GPS) device, and transmits position information measured by the GPS device to the information processing apparatus 14.

The information processing apparatus 14 receives the position information transmitted from the mobile terminal 12 and handles this position information as position information of a player holding the mobile terminal 12.

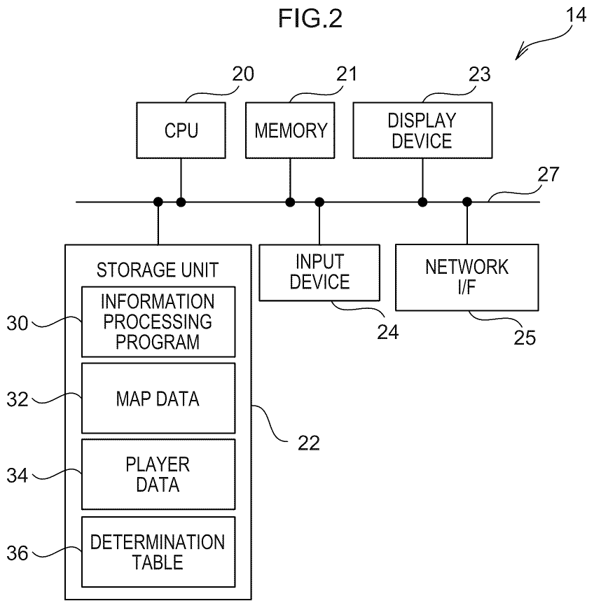

Next, a hardware configuration of the information processing apparatus 14 according to the embodiment will be described with reference to FIG. 2. As illustrated in FIG. 2, the information processing apparatus 14 includes a central processing unit (CPU) 20, a memory 21 as a temporary storage area, and a nonvolatile storage unit 22.

In addition, the information processing apparatus 14 includes a display device 23 such as a liquid crystal display, an input device 24 such as a keyboard and a mouse, and a network interface (I/F) 25 connected to a network. The CPU 20, the memory 21, the storage unit 22, the display device 23, the input device 24, and the network I/F 25 are connected to a bus 27.

The CPU 20 is an example of a processor according to the disclosed technology.

The storage unit 22 is implemented by a hard disk drive (HDD), a solid state drive (SSD), a flash memory, or the like. The storage unit 22 as a storage medium stores an information processing program 30. The CPU 20 reads the information processing program 30 from the storage unit 22, develops the information processing program 30 in the memory 21, and executes the developed information processing program 30.

In addition, the storage unit 22 stores map data 32, player data 34, and a determination table 36. The map data 32 includes map information of roads, facilities, administrative divisions, and the like. The player data 34 includes various types of data related to players associated with identification information of the players such as player IDs. The determination table 36 includes data used for level-up determination of the player to be described later.

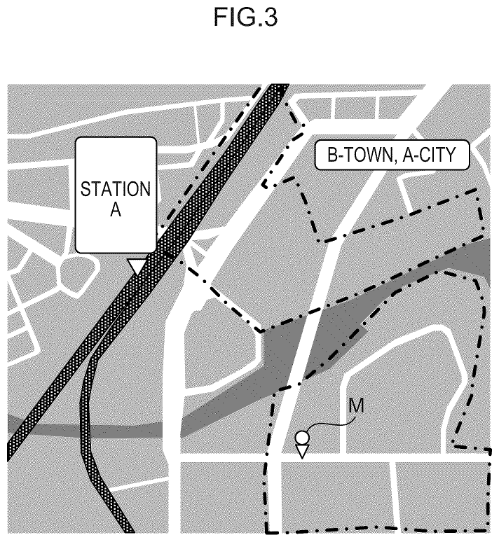

As illustrated in FIG. 3, in the position information game according to the embodiment, a geographical range (for example, a range corresponding to Japan in the map data 32) within which a player can move in the game is divided into a plurality of regions according to a specific rule. In the embodiment, the geographical range within which the player can move in the game is divided into a plurality of regions according to information of administrative divisions. That is, the respective regions do not necessarily have the same size, and at least two or more regions have different sizes. In the example of FIG. 3, a range surrounded by a one-dot chain line indicates a region. In addition, a mark M in the example of FIG. 3 indicates a current position of the player based on position information of the mobile terminal 12. When the player moves in a real space, the player also moves in a virtual space in the game on the basis of the position information of the player in the real space. Hereinafter, a position of the player in the virtual space corresponding to the real space is also sometimes referred to simply as the position of the player.

In the position information game according to the embodiment, a player acquires a region in the game corresponding to the position information of the player when a predetermined condition is satisfied. Examples of the predetermined condition include a condition that the position of the player enters the region, and the player performs an operation for acquiring the region such as an operation of tapping a button to acquire the region, and wins against an enemy set in the region. The predetermined condition may also be a condition that the position of the player enters the region, or a condition that the player enters the region and the player performs an operation for acquiring the region.

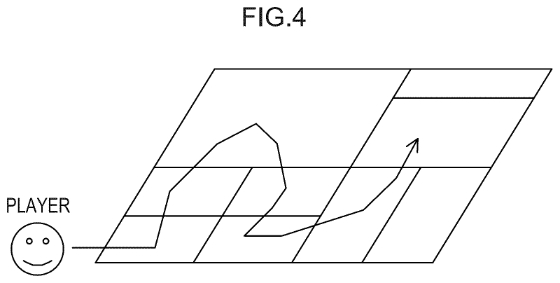

As illustrated in FIG. 4, a player acquires the region in the game corresponding to the position information of the player by satisfying the predetermined condition in the game while moving in the real space. In the example of FIG. 4, each quadrangle (parallelogram) indicates a region, and a solid arrow indicates a movement path of the player.

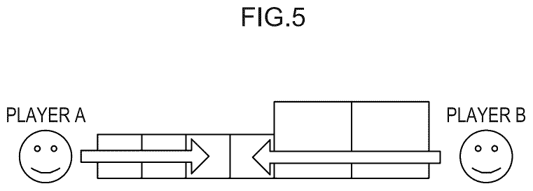

In such a position information game, for example, it is conceivable to update a degree of progress of the game of a player (for example, a level of the player) to a higher degree according to only the number of regions acquired by the player. In this case, as illustrated in FIG. 5, a situation in which the degree of progress of the game is unfair between players sometimes occurs. FIG. 5 illustrates an example of a case where a player is leveled up when the player acquires three regions. FIG. 5 illustrates an example in which player A acquires three relatively narrow regions, and player B acquires two relatively wide regions and one relatively narrow region. In this case, a moving distance required for level-up is shorter for the player A than that for the player B, which is an unfair situation.

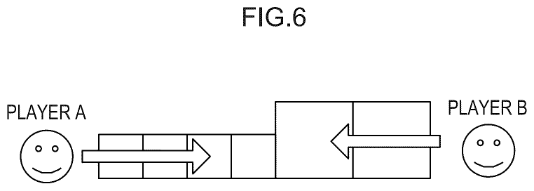

It is conceivable to update the degree of progress of the game of a player to a higher degree only according to only a size of a region acquired by the player. In this case, a situation in which the degree of progress of the game is unfair between players sometimes occurs as illustrated in FIG. 6. FIG. 6 illustrates an example of a case where a player is leveled up when an index value corresponding to a size of a relatively narrow region is 1, an index value corresponding to a size of a relatively wide region is 2, and a total value of the index values corresponding to the sizes of the regions acquired by the player is 3 or more. FIG. 6 illustrates an example in which player A acquires three relatively narrow regions, and player B acquires two relatively wide regions. In this case, a moving distance required for level-up is shorter for the player B than that for the player A, which is an unfair situation.

Therefore, the information processing apparatus 14 according to the embodiment has a function of updating a degree of progress of the game of a player (hereinafter, simply referred to as the “degree of progress”) according to the number and sizes of regions acquired by the player. Note that a case where identification information of a region acquired by the player and information related to the region such as an index value corresponding to a size of the region are stored in the player data 34 at a timing when the player acquires a region will be described hereinafter as an example. That is, when the player acquires a region, cumulative values of the number of the regions acquired by the player from the start of the game and the index values corresponding to the sizes of the regions can be acquired based on the player data 34. Hereinafter, a case where a level of the player is applied as the degree of progress will be described as an example. In the embodiment, as the level of the player increases, the number of usable functions increases or the number of usable characters increases, whereby the game progresses.

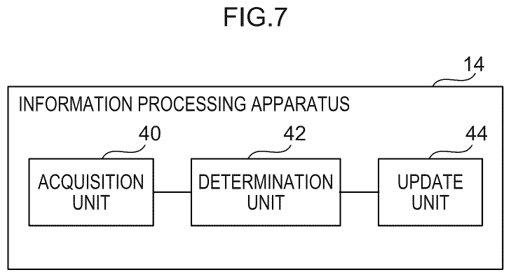

Next, a functional configuration of the information processing apparatus 14 will be described with reference to FIG. 7. As illustrated in FIG. 7, the information processing apparatus 14 includes an acquisition unit 40, a determination unit 42, and an update unit 44. The CPU 20 executes the information processing program 30 to function as the acquisition unit 40, the determination unit 42, and the update unit 44.

The acquisition unit 40 acquires a plurality of types of values related to scale of each of a plurality of regions acquired by a player. Specifically, when the player acquires a region, the acquisition unit 40 acquires the plurality of types of values related to the scale of each of the plurality of regions acquired by the player from the player data 34. In the embodiment, an example in which the cumulative value of the index values corresponding to the sizes of regions and the number of the regions are applied as the plurality of types of values related to the scale of the regions will be described. Here, the number of regions means a cumulative value of the number of regions acquired from the start of the game by the player. The index values corresponding to the sizes of the regions are set to have a larger value, for example, as the area of an administrative division corresponding to a region included in the map data 32 increases. In the embodiment, an example in which a yield (Kokudaka in Japanese) is applied as the index value corresponding to the size of the region will be described. The yield (Kokudaka) represents the productivity of land in the virtual space in the game indicated by rice crop (Koku in Japanese), and has a larger value as the area of the land is wider.

The determination unit 42 compares at least one type of value among the plurality of types of values acquired by the acquisition unit 40 with a threshold set according to the degree of progress. Specifically, when the player acquires a region, the determination unit 42 determines whether or not the cumulative value of each of the plurality of types acquired by the acquisition unit 40 is the threshold or larger set for each of the plurality of types of values according to the degree of progress.

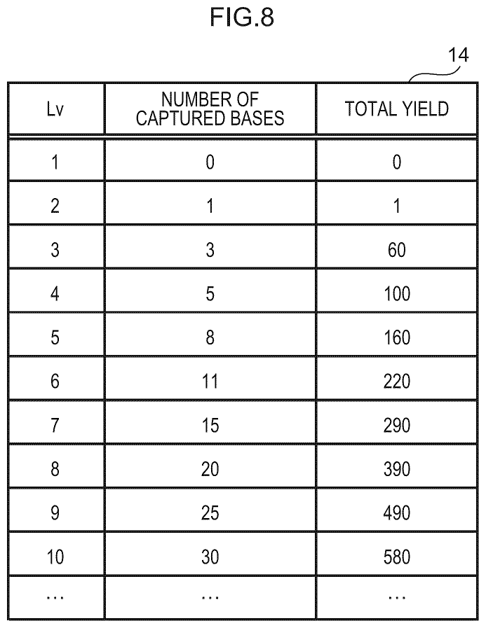

The determination unit 42 uses the determination table 36 for this determination. FIG. 8 illustrates an example of the determination table 36. As illustrated in FIG. 8, in the determination table 36, a threshold (hereinafter, referred to as “first threshold”) corresponding to the cumulative value of the index values corresponding to the sizes of the regions is stored in a column of a total yield for each level as an example of the degree of progress. In addition, in the determination table 36, a threshold (hereinafter, referred to as a “second threshold”) corresponding to the number of regions is stored in a column of the number of captured bases for each level.

In the embodiment, the determination unit 42 acquires the first threshold and the second threshold set for a level one level higher than a current level of the player from the determination table 36. Then, the determination unit 42 determines whether or not the cumulative value of the index values corresponding to the sizes of regions acquired by the player and the number of the regions acquired by the player, which are acquired by the acquisition unit 40, are the first threshold or larger and the second threshold or larger, respectively.

Note that the determination unit 42 may calculate the first threshold by multiplying the second threshold by a representative value of the index values corresponding to the sizes of the regions of the plurality of regions. Examples of the representative value in this case include an average value, a median value, a mode value, and the like. For example, the representative value is a numerical value selected to fall within a certain range from the average value of the index values, and is a numerical value falling within a range of 20% from the average value. Since the representative value falls within the certain range from the average value of the index values, as a result, the first threshold is set to a numerical value that falls within a certain range from a value obtained by multiplying the second threshold by the average value. When the second threshold is set to the representative value of the index values corresponding to the sizes of the regions of the plurality of regions in this manner, it is possible to suppress unfairness between players.

The update unit 44 updates the degree of progress using at least one type of value among the plurality of types of values acquired by the acquisition unit 40. In the embodiment, the update unit 44 updates the degree of progress to a higher degree in a case in which the determination unit 42 determines that the cumulative value of the index values corresponding to the sizes of the regions acquired by the player is equal to or larger than the first threshold and the number of the regions acquired by the player is equal to or larger than the second threshold. Specifically, in this case, the update unit 44 adds 1 to the current level of the player and stores the updated level in the player data 34.

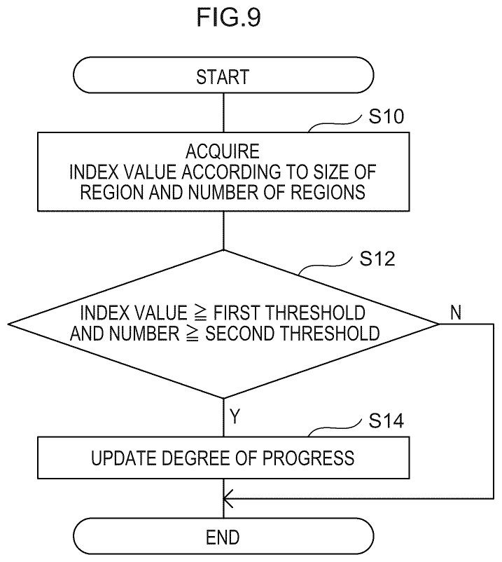

Next, an operational effect of the information processing apparatus 14 will be described with reference to FIG. 9. When the CPU 20 executes the information processing program 30, a progress degree update process illustrated in FIG. 9 is executed. The progress degree update process illustrated in FIG. 9 is executed, for example, when a player acquires a region.

In step S10 of FIG. 9, as a plurality of types of values related to scale of each of a plurality of regions acquired by the player, the acquisition unit 40 acquires a cumulative value of index values corresponding to sizes of the regions and the number of the regions as described above. In step S12, the determination unit 42 refers to the determination table 36 to determine whether or not the cumulative value of the index values corresponding to the sizes of regions acquired by the player and the number of the regions acquired by the player, which are acquired in step S10, are the first threshold or larger and the second threshold or larger, respectively, as described above. In a case in which a positive determination is made in this determination, the processing proceeds to step S14.

In step S14, the update unit 44 updates a degree of progress to a higher degree as described above. When the processing in step S14 ends, the progress degree update process ends. In a case in which a negative determination is made in the determination in step S12, the processing in step S14 is not executed, and the progress degree update process ends.

As described above, it is possible to suppress the unfairness in the degree of progress of the game for each player according to the embodiment.

Although the case where the update unit 44 raise the level of the player one by one as the degree of progress has been described in the above embodiment, the disclosed technology is not limited to such an aspect. The update unit 44 may raise the level of the player by an increase of two or more levels. In this case, the first threshold and the second threshold of the determination table 36 may be prepared for each number of levels raised by the update unit 44.

Although the case where each of the first threshold and the second threshold of the determination table 36 is determined according to the cumulative value has been described in the above embodiment, the disclosed technology is not limited to such an aspect. As each of the first threshold and the second threshold of the determination table 36, a value required for updating a degree of progress from a previous degree of progress may be set for each degree of progress. In this case, for example, in the determination table illustrated in FIG. 8, the first threshold and the second threshold corresponding to each level are differences from the first threshold and the second threshold of the previous level. In addition, in this case, the update unit 44 may update the degree of progress to a higher degree in a case in which any one type of value of the plurality of types of values acquired by the player after being updated in the degree of progress most recently becomes a threshold or larger set according to the degree of progress for the one type of value of the plurality of types of values. Specifically, the update unit 44 may level up the player when a cumulative value of index values corresponding to sizes of regions acquired by the player after the most recent level up becomes the first threshold or larger or when the number of the regions becomes the second threshold or larger.

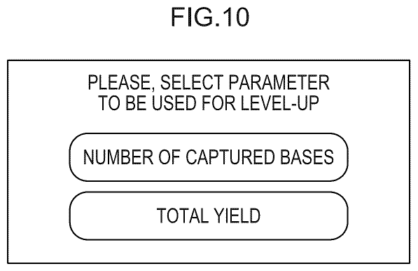

In addition, when the degree of progress is updated, the update unit 44 may perform presentation such that the player can select any of the plurality of types of values to be used for updating the degree of progress. In this case, as illustrated in FIG. 10, a screen that allows the player to select a parameter to be used for updating the degree of progress is displayed on the display device of the mobile terminal 12. In the example of FIG. 10, the player taps a button described as “number of captured bases” in the case ofusing the number of regions to determine level-up. In addition, in the example of FIG. 10, the player taps a button described as “total yield” in the case of using the index value corresponding to the size of the region to determine level-up.

In the above embodiment, the update unit 44 may further update the degree of progress using at least one of a value of land in the real space corresponding to the region acquired by the player, a moving speed of the player in the real space, and a moving time of the player in the real space.

The value of the land in the real space is not a value in the game but a value evaluated by a predetermined evaluation axis in the real world. For example, it is a value calculated according to the number of buildings in the land included in the map data. In addition, a point of time set as a reference for the moving speed and the moving time of the player may be a point of time when the player acquired a region last time, a point of time when the degree of progress of the player was updated last time, or a point of time when the game started.

Specifically, for example, the update unit 44 may decrease the number of regions required for updating the degree of progress as the value of the land in the real space corresponding to the region acquired by the player is higher. In this case, the player can easily raise the level by preferentially acquiring a region having a higher value of land in the real space. In addition, for example, the update unit 44 may decrease the number of regions required for updating the degree of progress as the moving speed of the player in the real space is slower. In this case, the player can easily raise the level by acquiring a region by moving on foot at a speed lower than that of a train, an automobile, or the like. In addition, for example, the update unit 44 may decrease the number of regions required for updating the degree of progress as the moving time of the player in the real space is longer. Also in this case, the player can easily raise the level by acquiring a region by moving on foot that requires a longer time for moving the same distance than a train, an automobile, or the like.

In the above embodiment, the CPU 20 may present a threshold set according to the degree of progress for at least one type of value among the plurality of types of values used for updating the degree of progress. In this case, as in the example illustrated in FIG. 8, the threshold set according to the degree of progress is displayed on the display device of the mobile terminal 12 in a tabular form.

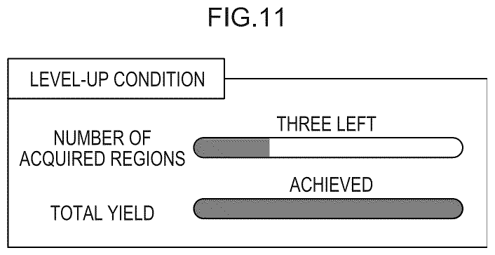

In the above embodiment, the CPU 20 may present a threshold set according to the next degree of progress for at least one type of value among the plurality of types of values used for updating the degree of progress. In addition, in this case, the CPU 20 may present achievement status up to the threshold set according to the next degree of progress for at least one type of value among the plurality of types of values used for updating the degree of progress. In this case, as an example, a condition until reaching the next degree of progress is displayed on the display device of the mobile terminal 12 as illustrated in FIG. 11. FIG. 11 illustrates an example of a case where a player is leveled up if further acquiring three regions.

In the above embodiment, the CPU 20 may present a map in which at least one type of value among the plurality of types of values is also described for each region. In this case, for example, an index value corresponding to a size of each region is displayed on the display device of the mobile terminal 12 together with the map.

In addition, the processing executed by the CPU 20 reading software (the program) in the above embodiment may be executed by various processors other than the CPU. Examples of the processors in this case include a programmable logic device (PLD) whose circuit configuration can be changed after manufacturing, such as a field programmable gate array (FPGA), a dedicated electric circuit that is a processor having a circuit configuration exclusively designed for executing specific processing, such as an application specific integrated circuit (ASIC), and the like.

In addition, the processing executed by the CPU 20 reading the software (program) may be executed by one of the various processors, or may be executed by any combination of two or more processors of the same or different types (for example, a plurality of FPGAs, any combination of a CPU and an FPGA, and the like). More specifically, a hardware structure of the various processors is an electric circuit in which circuit elements such as semiconductor elements are combined.

Although an aspect in which the information processing program 30 is stored (installed) in advance in the storage unit 22 has been described in the above embodiment, the invention is not limited thereto. The information processing program 30 may be provided in a form of being recorded in a recording medium such as a compact disc read only memory (CD-ROM), a digital versatile disc read only memory (DVD-ROM), or a universal serial bus (USB) memory. In addition, the information processing program 30 may be downloaded from an external device via a network.

What is claimed is:

1. A non-transitory computer-readable recording medium in which an information processing program is recorded, the information processing program causing a computer to execute:
acquiring a plurality of types of values related to scale of each of a plurality of the regions acquired by the player
in a position information game for acquiring the region in the game corresponding to position information of the player when a predetermined condition is satisfied; and
updating a degree of progress of the game of the player by using at least one type of value among the plurality of types of values.

2. The non-transitory computer-readable recording medium in which the information processing program is recorded according to claim 1, wherein
the plurality of types of values related to the scale of the regions include an index value corresponding to a size of each of the regions and a number of the regions.

3. The non-transitory computer-readable recording medium in which the information processing program is recorded according to claim 1, wherein
the degree of progress is upgraded by comparing at least one type of value among the plurality of types of values with a threshold set according to the degree of progress.

4. The non-transitory computer-readable recording medium in which the information processing program is recorded according to claim 3, wherein
the degree of progress is upgraded to a higher degree in a case in which a cumulative value of each of the plurality of types of values becomes a threshold or larger set according to the degree of progress for each of the plurality of types of values.

5. The non-transitory computer-readable recording medium in which the information processing program is recorded according to claim 3, wherein
the degree of progress is upgraded to a higher degree in a case in which any one type of value of the plurality of types of values acquired by the player after being upgraded in the degree of progress most recently becomes a threshold or larger set according to the degree of progress for any one type of value of the plurality of types of values.

6. The non-transitory computer-readable recording medium in which the information processing program is recorded according to claim 2, wherein
a first threshold used for comparison with the index value is calculated by multiplying a second threshold, used for comparison with the number, by a representative value of the index values of the plurality of regions.

7. The non-transitory computer-readable recording medium in which the information processing program is recorded according to claim 1, wherein
presentation is performed in a case in which the degree of progress is updated such that the player is capable of selecting any of the plurality of types of values to be used for updating the degree of progress.

8. The non-transitory computer-readable recording medium in which the information processing program is recorded according to claim 1, wherein
the degree of progress is upgraded further using at least one of a value of land in a real space corresponding to the region, a moving speed of the player in the real space, and a moving time of the player in the real space.

9. An information processing method comprising:
acquiring, by a computer, a plurality of types of values related to scale of each of a plurality of regions acquired by a player
in a position information game for acquiring the region in the game corresponding to position information of the player when a predetermined condition is satisfied; and
updating, by the computer, a degree of progress of the game of the player by using at least one type of value among the plurality of types of values.

10. An information processing apparatus comprising a processor, the processor being configured to:
acquire a plurality of types of values related to scale of each of a plurality of regions acquired by a player in a position information game for acquiring the regions in the game corresponding to position information of the player when a predetermined condition is satisfied; and
update a degree of progress of the game of the player by using at least one type of value among the plurality of types of values.
